(19) United States
(12) Patent Application Publication
(10) Pub. No.: US 2022/0057887 A1
(43) Pub. Date: Feb. 24, 2022

(54) TOUCH SCREEN CONTROL METHOD AND SYSTEM

(71) Applicant: Compal Electronics, Inc., Taipei City (TW)

(72) Inventors: Ta-Wei Liu, Taipei City (TW); Pu-Wei Wang, Taipei City (TW)

(21) Appl. No.: 17/080,479

(22) Filed: Oct. 26, 2020

(30) Foreign Application Priority Data
Aug. 20, 2020 (TW) 109128436

(51) Int. Cl. G06F 3/041

(52) U.S. Cl. CPC G06F 3/0418; G06F 1/1698; G06F 3/04164

(57) ABSTRACT

The present disclosure provides a touch screen control method and system. The touch screen control method includes steps of: (a) providing a smart device, wherein the smart device includes a touch screen and a sensor, the smart device has a software architecture, the software architecture includes an application layer, an application architecture layer, a hardware abstraction layer and a kernel layer, and the touch screen is controlled by a driver of the kernel layer; (b) utilizing the sensor to determine if an object is approaching to the touch screen when the smart device is in a call mode, performing a step (c) if the determining result is satisfied, performing the step (b) again if the determining result is not satisfied; (c) transmitting a sensing signal to the kernel layer through the hardware abstraction layer; and (d) turning off a specific area of the touch screen.

### CROSS-REFERENCE TO RELATED APPLICATION

This application claims priority to Taiwan Patent Application No. 109128436, filed on Aug. 20, 2020, the entire content of which is incorporated herein by reference for all purposes.

### FIELD OF THE INVENTION

The present disclosure relates to a touch screen control method and system, and more particularly to a touch screen control method and system for preventing accidental touches.

### BACKGROUND OF THE INVENTION

Smart devices are becoming more and more popular recently. During a user utilizing a smart device to make a phone call, the user often accidentally touches the touch screen while bringing the smart device close to the face.

Take the software architecture of the Android operating system as an example. When the sensor of the smart device detects the approach of a human face, the sensor sends a notification message through its driver. The notification message is transmitted to the processor of the smart device through the Hardware Abstraction Layer (HAL), the Application Frameworks Layer and the Application Layer in sequence. The processor issues an instruction to turn off the touch screen. The instruction is transmitted to the touch screen through the Application Layer, the Application Framework Layer and the Hardware Abstraction Layer in order. The touch screen then turns off the touch screen according to the instruction so that the human face will not accidentally touch the touch screen. However, the transmission of the above message and instruction takes too much time, which causes that the touch screen cannot be turned off immediately when the human face is approaching, so false touches still often occur.

Therefore, there is a need of providing a touch screen control method and system to obviate the drawbacks encountered from the prior arts.

### SUMMARY OF THE INVENTION

It is an object of the present disclosure to provide a touch screen control method and system. During the call mode, when the sensor detects an object approaching to the touch screen, the sensor utilizes the hardware abstraction layer to transmit the sensing signal to the touch screen, and the touch screen is turned off. The sensing signal in the present application does not need to go through the complicated message transmission process and communication process in conventional software architecture. Therefore, the touch screen can be prevented from being incapable of turning off immediately due to the excessive time spent on message transmission, thereby reducing the probability of false touch.

In accordance with an aspect of the present disclosure, there is provided a touch screen control method. The touch screen control method includes steps of: (a) providing a smart device, wherein the smart device includes a touch screen and a sensor, the smart device has a software architecture, the software architecture includes an application layer, an application architecture layer, a hardware abstraction layer and a kernel layer, and the touch screen is controlled by a driver of the kernel layer; (b) utilizing the sensor to determine if an object is approaching to the touch screen when the smart device is in a call mode, performing a step (c) if the determining result is satisfied, and performing the step (b) again if the determination result is not satisfied; (c) transmitting a sensing signal to the kernel layer through the hardware abstraction layer; and (d) turning off a specific area of the touch screen.

In accordance with an aspect of the present disclosure, there is provided a touch screen control system. The touch screen control system includes an object and a smart device. The smart device includes a touch screen and a sensor, wherein the sensor is configured for sensing whether the object is approaching to the touch screen. Wherein the smart device has a software architecture, the software architecture includes an application layer, an application architecture layer, a hardware abstraction layer and a kernel layer, the touch screen is controlled by a driver of the kernel layer, wherein when the smart device enters a call mode and the sensor senses that the object is approaching to the smart device, the sensor transmits a sensing signal to the kernel layer through the hardware abstraction layer, and the kernel layer instructs the driver to turn off a specific area of the touch screen.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic view illustrating the position relationships in a touch screen control system according to an embodiment of the present disclosure;

FIG. 2 is a schematic block diagram illustrating a part of a touch screen control system according to an embodiment of the present disclosure;

FIG. 3 is a schematic block diagram illustrating a part of a touch screen control system according to another embodiment of the present disclosure;

FIG. 4 is a schematic screen diagram of the touch screen of the present disclosure;

FIG. 5 is a schematic block diagram illustrating the sampling period of the sensor of the present disclosure;

FIG. 6 is a statistical diagram of the relationship between the sampling period and the false touch rate;

FIG. 7 is a statistical diagram of the relationship between the sampling period and the average current;

FIG. 8 is a statistical diagram of the relationship between the false touch rate and the average current;

FIG. 9 is a flow chart illustrating a touch screen control method according to an embodiment of the present disclosure; and

FIG. 10 is a flow chart illustrating a touch screen control method according to another embodiment of the present disclosure.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

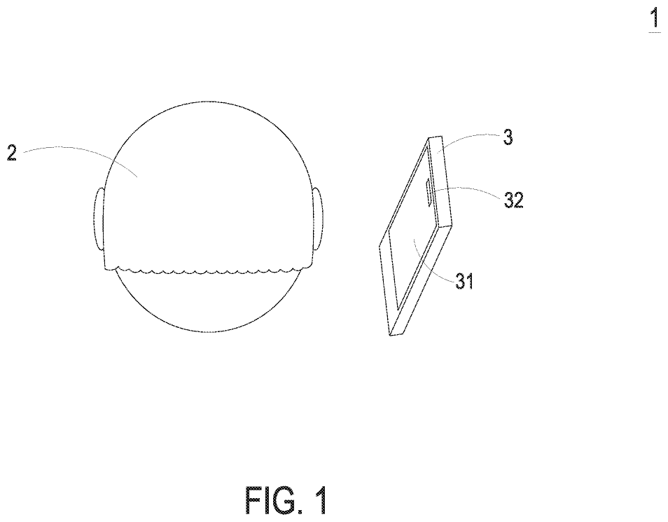

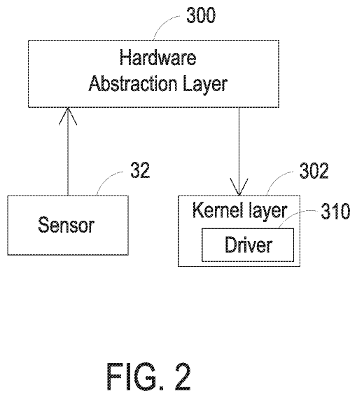

Please refer to FIGS. 1 and 2. FIG. 1 is a schematic view illustrating the position relationships in a touch screen control system according to an embodiment of the present disclosure. FIG. 2 is a schematic block diagram illustrating a part of a touch screen control system according to an embodiment of the present disclosure. The touch screen control system 1 includes an object 2 and a smart device 3. The smart device 3 includes a touch screen 31 and a sensor 32, and the sensor 32 is configured for sensing whether the object 2 is approaching to the touch screen 31. In an embodiment, the object 2 is a person's side face or ears. The smart device 3 has a software architecture, and the software architecture includes an application layer (not shown), an application architecture layer 301, a hardware abstraction layer 300 and a kernel layer 302. The touch screen 31 is controlled by a driver 310 of the kernel layer 302. The touch screen control system 1 enters a call mode when the smart device 3 is dialing or answering. When the smart device 3 enters the call mode and the sensor 32 senses that the object 2 is approaching to the smart device 3, the sensor 32 transmits a sensing signal to the kernel layer 302 through the hardware abstraction layer 300, and the kernel layer 302 instructs the driver 310 to turn off a specific area of the touch screen 31. Conventionally, the sensing signal may be firstly transmitted to the application layer and the application architecture layer 301 of the software architecture, and then the application program of the application architecture layer 301 instructs the driver 310 of the kernel layer 302 to turn off the touch screen 31. However, in the present disclosure, the sensing signal is directly transmitted to the driver 310 through the hardware abstraction layer 300. Consequently, the sensing signal in the present application does not need to go through the complicated message transmission process and communication process in conventional software architecture. Accordingly, the touch screen can be prevented from being incapable of turning off immediately due to the excessive time spent on message transmission, thereby reducing the probability of false touch.

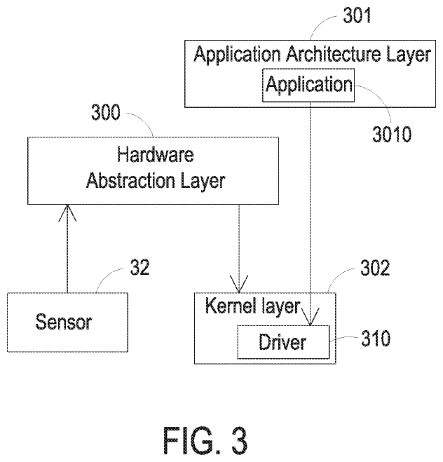

Please refer to FIGS. 1 and 3. FIG. 3 is a schematic block diagram illustrating a part of a touch screen control system according to another embodiment of the present disclosure. In an embodiment, when the user receives a phone call, the modem of the smart device 3 notifies the application architecture layer 301 that the smart device 3 has entered the call mode. Then, the application program 3010 of the application architecture layer 301 transmits a notification signal to the driver 310 of the kernel layer 302. The driver 310 turns off a specific area of the touch screen 31 when receiving the sensing signal and the notification signal at the same time, so as to ensure that the specific area of the touch screen 31 is turned off when the smart device 3 is in the call mode.

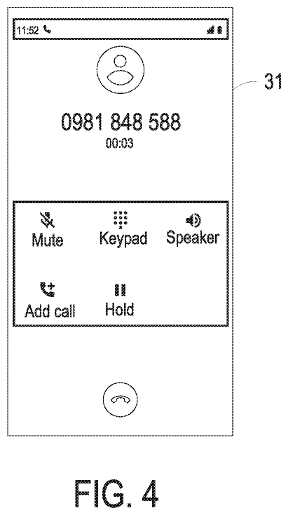

Please refer to FIG. 4. FIG. 4 is a schematic screen diagram of the touch screen of the present disclosure. The thick black frame in FIG. 4 represents the specific area of the touch screen 31. The specific area includes touch areas such as but not limited to the status bar, the speaker key, and the mute key in the touch screen 31. Therefore, when the object 2 is approaching to the touch screen 31 during the call mode, the object 2 is prevented from accidentally touching the aforementioned touch areas.

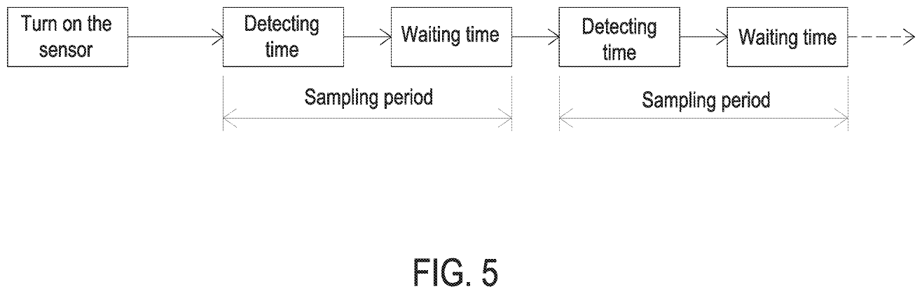

Please refer to FIG. 5. FIG. 5 is a schematic block diagram illustrating the sampling period of the sensor of the present disclosure. In an embodiment, the time required for the sensor 32 to perform one sampling is a sampling period, and the sampling period includes a detection time and a waiting time. The detecting time is the time for proximity sensing, and there is a waiting time after the detection time. Specifically, a proximity sensing is performed in each sampling period, and a waiting is performed after the proximity sensing. Further, the performing of the proximity sensing and the waiting take the detection time and the waiting time respectively. By setting the waiting time, the sensor 32 can be prevented from performing proximity sensing excessively frequently and causing excessive consumption of power.

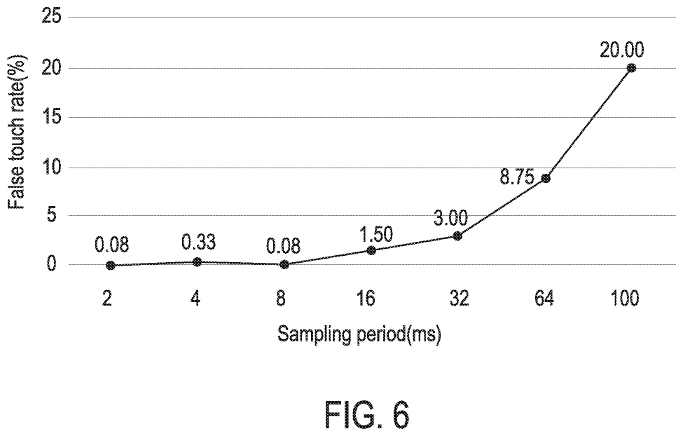

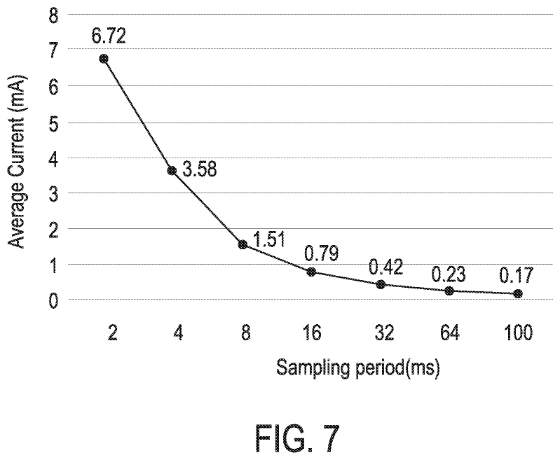

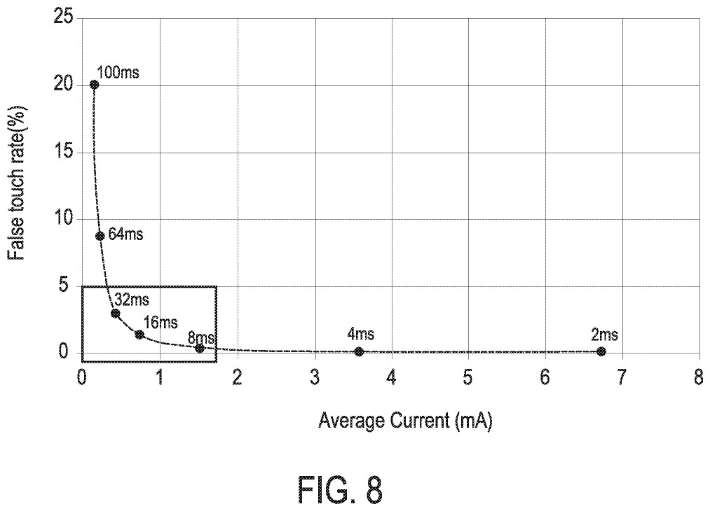

The setting of the sampling period needs to consider the false touch rate of the touch screen 31 and the power consumption of the smart device 3 at the same time. In an embodiment, the false touch rate of the touch screen 31 is based on the event statistics of the object 2 accidently touching the touch screen 3 when the smart device 3 being in the call mode. In an embodiment, the power consumption of the smart device 3 is reflected by the average current of the smart device 3. When the sampling period is short, which means that the sampling frequency is large, the false touch rate of the touch screen 3 is reduced, but the power consumption of the smart device 3 is increased at the same time. Conversely, when the sampling period is long, which means that the sampling frequency is small, the power consumption of the smart device 3 is reduced, but the false touch rate of the touch screen 3 is increased at the same time. Please refer to FIGS. 6, 7 and 8. FIG. 6 is a statistical diagram of the relationship between the sampling period and the false touch rate. FIG. 7 is a statistical diagram of the relationship between the sampling period and the average current. FIG. 8 is a statistical diagram of the relationship between the false touch rate and the average current. In FIGS. 6 and 7, m pieces of call data of different sampling periods. In the m pieces of call data, each sampling period has the corresponding false touch rate and average current. FIG. 8 is a statistical diagram based on the false touch rate and average current collected in FIGS. 6 and 7 during different sampling periods. In FIG. 8, the thick black frame represents the interval of the appropriate false touch rate and average current under the selected sampling period. For example, in this embodiment, the sampling period is set between 8 ms and 32 ms. Accordingly, the corresponding false touch rate is less than 5%, and the average current is less than 2 mA.

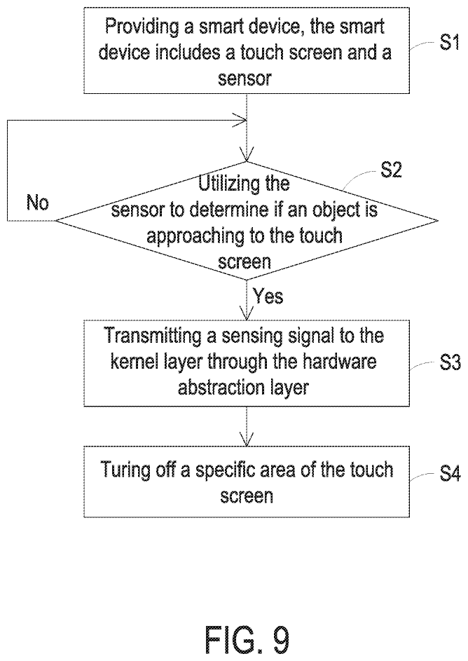

Please refer to FIG. 9. FIG. 9 is a flow chart illustrating a touch screen control method according to an embodiment of the present disclosure. The touch screen control method of the present disclosure is applicable for the touch screen control system 1 stated above. The touch screen control method includes steps S1, S2, S3 and S4. In step S1, a smart device 3 is provided, and the smart device 3 includes a touch screen 31 and a sensor 32. The smart device 3 includes a software architecture, and the software architecture includes an application layer, an application architecture layer 301, a hardware abstraction layer 300 and a kernel layer 302. The touch screen 31 is controlled by a driver 310 of the kernel layer 302. In step S2, the sensor 32 determines if an object 2 is approaching to the touch screen when the smart device is in a call mode. Step S3 is performed if the determining result of step S2 is satisfied, and step S2 is performed again if the determining result of step S2 is not satisfied. In step S3, a sensing signal is transmitted to the kernel layer 302 through the hardware abstraction layer 300. In step S4, a specific area of the touch screen is turned off.

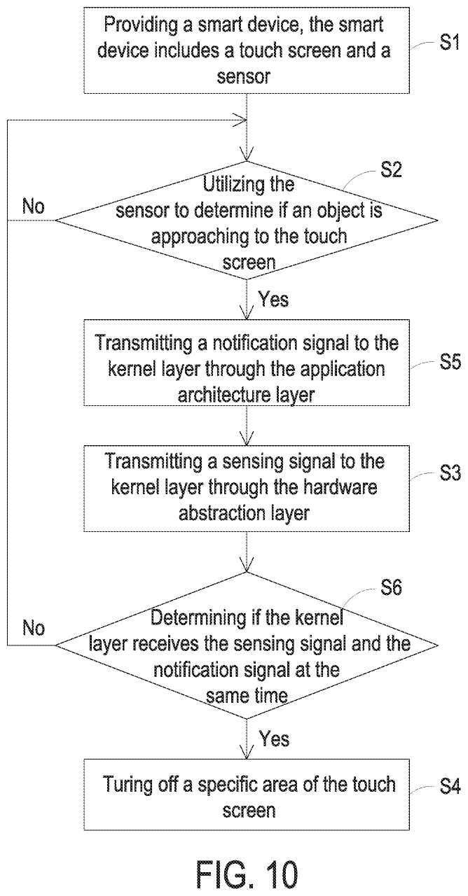

Please refer to FIG. 10. FIG. 10 is a flow chart illustrating a touch screen control method according to another embodiment of the present disclosure. The steps that are the same as those in FIG. 9 are represented by the same reference numerals, and the detailed description is omitted herein. In this embodiment, the touch screen control method further includes a step S5 between steps S2 and S4. In step S5, a notification signal is transmitted to the kernel layer 302 through the application architecture layer 301. In addition, the touch screen control method further includes a step S6 before step S4. In step S6, whether the kernel layer 302 receives the sensing signal and notification signal at the same time is determined. Step S4 is performed if the determining result of step S6 is satisfied, and step S2 is performed again if the determining result of step S6 is not satisfied.

From the above descriptions, the present disclosure provides a touch screen control system and method. During the call mode, when the sensor detects an object approaching to the touch screen, the sensor utilizes the hardware abstraction layer to transmit the sensing signal to the touch screen, and the touch screen is turned off. The sensing signal in the present application does not need to go through the complicated message transmission process and communication process in conventional software architecture. Therefore, the touch screen can be prevented from being incapable of turning off immediately due to the excessive time spent on message transmission, thereby reducing the probability of false touch.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. A touch screen control method, comprising steps of:
(a) providing a smart device, wherein the smart device comprises a touch screen and a sensor, the smart device has a software architecture, the software architecture comprises an application layer, an application architecture layer, a hardware abstraction layer and a kernel layer, and the touch screen is controlled by a driver of the kernel layer;
(b) utilizing the sensor to determine if an object is approaching to the touch screen when the smart device is in a call mode, performing a step (c) if the determining result is satisfied, and performing the step (b) again if the determining result is not satisfied;
(c) transmitting a sensing signal to the kernel layer through the hardware abstraction layer; and
(d) turning off a specific area of the touch screen,
wherein the touch screen control method further comprising a step (e) between the steps (b) and (d);
(e) transmitting a notification signal to the kernel layer through the application architecture layer,
wherein the touch screen control method further comprising a step (f) before the step (d);
(f) determining if the kernel layer receives the sensing signal and notification signal at the same time, performing the step (d) if the determining result is satisfied, and performing the step (b) again if the determining result is not satisfied.

2. (canceled)

3. (canceled)

4. The touch screen control method according to claim 1, wherein a sampling period of the sensor is set in the step (b), the sampling period comprises a detecting time and a waiting time, the detecting time is a time for performing the proximity sensing, and the waiting time is after the detection time.

5. A touch screen control system, comprising:
an object; and
a smart device comprising a touch screen and a sensor, wherein the sensor is configured for sensing whether the object is approaching to the touch screen;
wherein the smart device has a software architecture, the software architecture comprises an application layer, an application architecture layer, a hardware abstraction layer and a kernel layer, the touch screen is controlled by a driver of the kernel layer, wherein when the smart device enters a call mode and the sensor senses that the object is approaching to the smart device, the sensor transmits a sensing signal to the kernel layer through the hardware abstraction layer, and the kernel layer instructs the driver to turn off a specific area of the touch screen,
wherein the application architecture of the smart device transmits a notification signal to the kernel layer,
wherein a specific area of the touch screen is turned off when the kernel layer receives the sensing signal and the notification signal at the same time.

6. (canceled)

7. (canceled)

8. The touch screen control system according to claim 5, wherein the sensor has a sampling period, the sampling period comprises a detecting time and a waiting time, the detecting time is a time of performing the proximity sensing, and the waiting time is after the detection time.
